(19) United States
(12) Patent Application Publication
(10) Pub. No.: US 2026/0161260 A1
(43) Pub. Date: Jun. 11, 2026

(54) SYSTEMS AND METHODS OF SHARING INFORMATION BASED ON A REQUEST FOR INFORMATION

(71) Applicant: Apple Inc., Cupertino, CA (US)

(72) Inventors: James D. DUSSEAU, Santa Clara, CA (US); Noah GAMBOA, San Francisco, CA (US); Colton J. CHESNUT, San Diego, CA (US); Jeffrey S. NORRIS, Saratoga, CA (US)

(21) Appl. No.: 19/380,270

(22) Filed: Nov. 5, 2025

Related U.S. Application Data
(60) Provisional application No. 63/729,249, filed on Dec. 6, 2024.

(51) Int. Cl. G06F 3/0481; G06F 3/01; G06F 3/0487

(52) U.S. Cl. CPC G06F 3/0481; G06F 3/011; G06F 3/0487

(57) ABSTRACT

Some examples of the disclosure are directed to systems and methods for sharing information based on a request for information. In some examples, the electronic device receives a request for information from a source (e.g., a second electronic device different than the electronic device or a person in the physical environment of the electronic device). In some examples, based on the context of the electronic device (e.g., based on how the request for information was received, the environmental context when receiving the request for information, and/or the application(s) receiving the request for information), the electronic device displays respective information in response to receiving the request for information. In some examples, the electronic device captures environmental context using one or more input devices. In some examples, the electronic device uses the environmental context to determine detect a request for information and/or provide information corresponding to the request for information.

### CROSS-REFERENCE TO RELATED APPLICATIONS

This application claims the benefit of U.S. Provisional Application No. 63/729,249, filed Dec. 6, 2024, the content of which is herein incorporated by reference in its entirety for all purposes.

### FIELD OF THE DISCLOSURE

This relates generally to systems and methods of sharing information based on a request for information. Specifically, this relates to sharing information based on environmental context and/or data stored on an electronic device in response to detecting a request for information.

### BACKGROUND OF THE DISCLOSURE

Some computer graphical environments provide two-dimensional and/or three-dimensional environments where at least some objects displayed for a user's viewing are virtual and generated by a computer. In some examples, the electronic device presents objects including information relating to a request for information.

### SUMMARY OF THE DISCLOSURE

Some examples of the disclosure are directed to systems and methods for sharing information based on a request for information. In some examples, the electronic device receives a request for information from a source (e.g., a second electronic device different than the electronic device or a person in the physical environment of the electronic device). In some examples, based on the context of the electronic device (e.g., based on how the request for information was received, the environmental context when receiving the request for information, and/or the application(s) receiving the request for information), the electronic device displays respective information in response to receiving the request for information. In some examples, the electronic device captures environmental context using one or more input devices. In some examples, the electronic device uses the environmental context to detect a request for information and/or provide information corresponding to the request for information.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIGS. 2A-2B illustrate block diagrams of example architectures for electronic devices according to some examples of the disclosure.

FIGS. 3A-3G illustrate examples of the electronic device providing information based on a first request for information according to some examples of the disclosure.

FIGS. 4A-4C illustrate an example of the electronic device providing information based on a second request for information according to some examples of the disclosure.

FIGS. 5A-5D illustrate a different example of an electronic device receiving a request for information from a different source and providing the respective information according to some examples of the disclosure.

FIGS. 6A-6C illustrate an example where the electronic device 101 detects and summarizes information for the request for information according to some examples of the disclosure.

FIG. 7 illustrates a block diagram illustrating the process for providing a suggestion to a request for information according to some examples of the disclosure.

FIG. 8 illustrates a flow diagram illustrating an example process for displaying suggestions to requests for information according to some examples of the disclosure.

### DETAILED DESCRIPTION

Some examples of the disclosure are directed to systems and methods for sharing information based on a request for information. In some examples, the electronic device receives a request for information from a source (e.g., a second electronic device different than the electronic device or a person in the physical environment of the electronic device). In some examples, based on the context of the electronic device, the electronic device displays respective information in response to receiving the request for information. In some examples, the electronic device captures environmental context using one or more input devices. In some examples, the electronic device uses the environmental context to determine a request for information and/or provide information corresponding to the request for information.

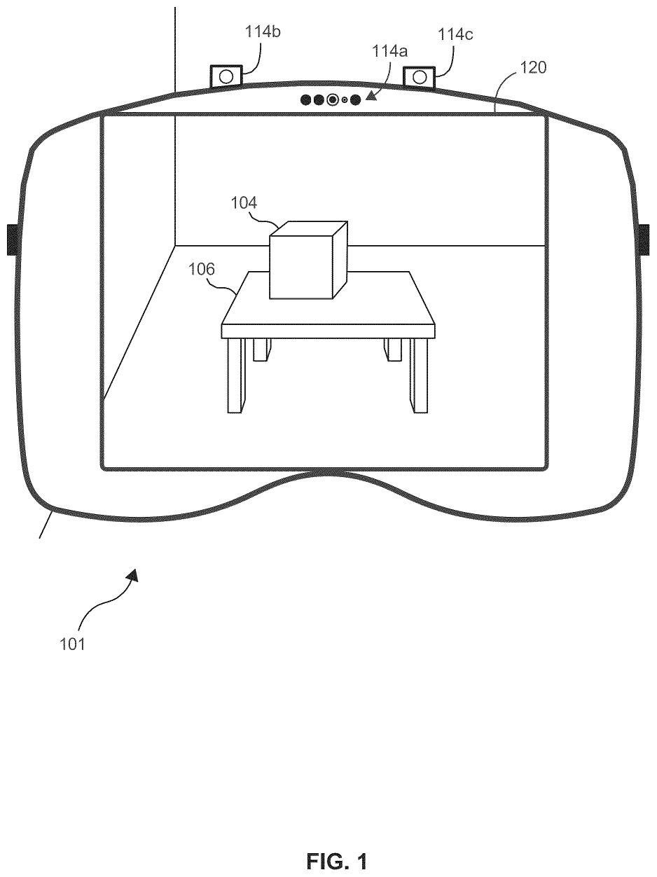

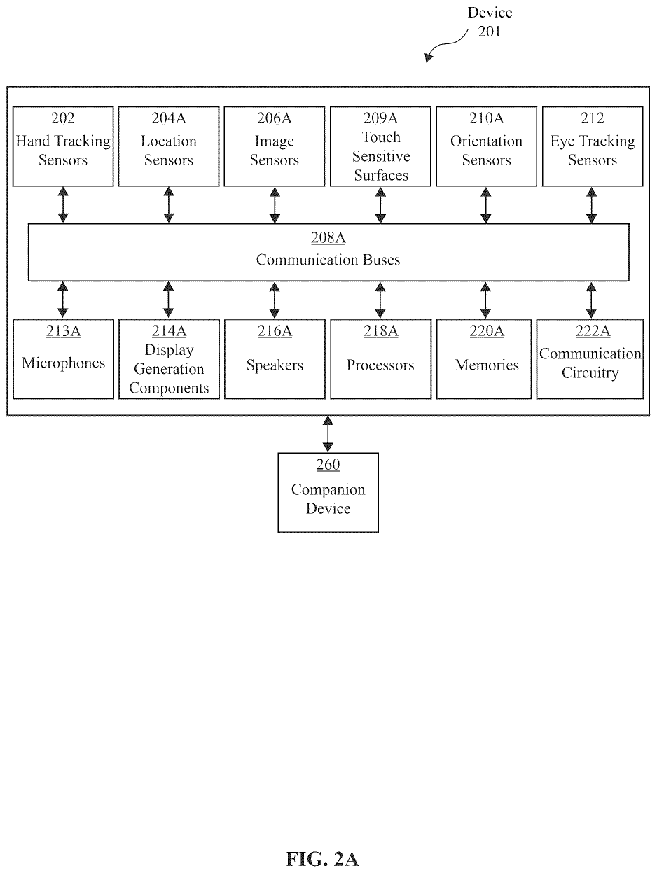

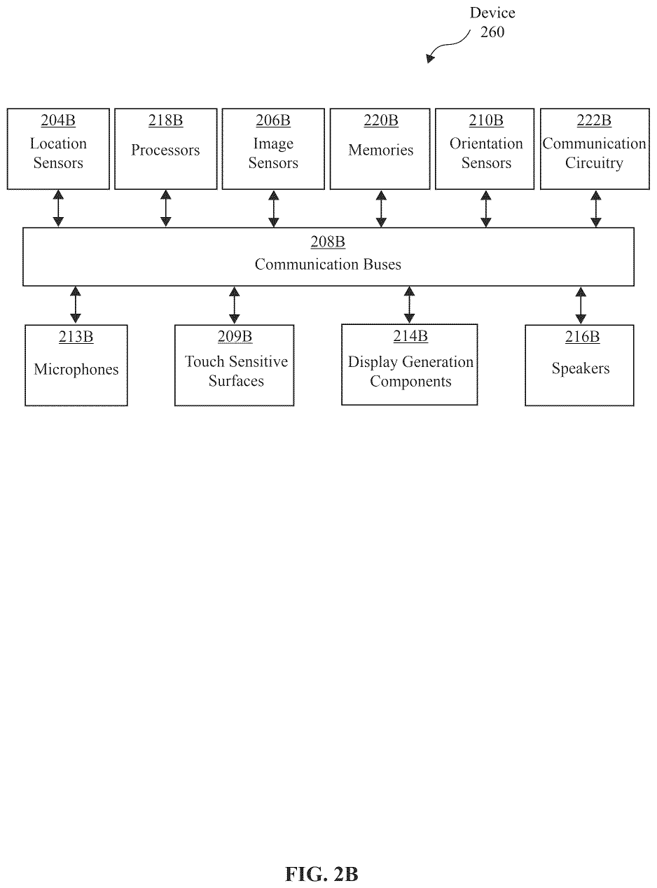

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards interactions with one or more virtual objects that are displayed in a three-dimensional environment presented at an electronic device (e.g., corresponding to electronic device 201). The information is optionally displayed as a virtual object or as part of a virtual object in the three-dimensional environment. In some examples, an electronic device receives a request for information (e.g., from the electronic device or from a second electronic device) while displaying a user interface of a first application. In some examples, while the electronic device is in a first context (e.g., determined based on the first application and/or by environmental context), the electronic device displays a first information corresponding to the request for information. In some examples, if the electronic device is in a second context, the electronic device displays a second information corresponding to the request for information. In some examples, the electronic device uses data stored on the electronic device or stored remotely on a different electronic device in communication with the electronic device provide the respective information to be displayed in response to the request for information. In some examples, the electronic device uses machine learning and/or artificial intelligence to determine and/or provide the respective information.

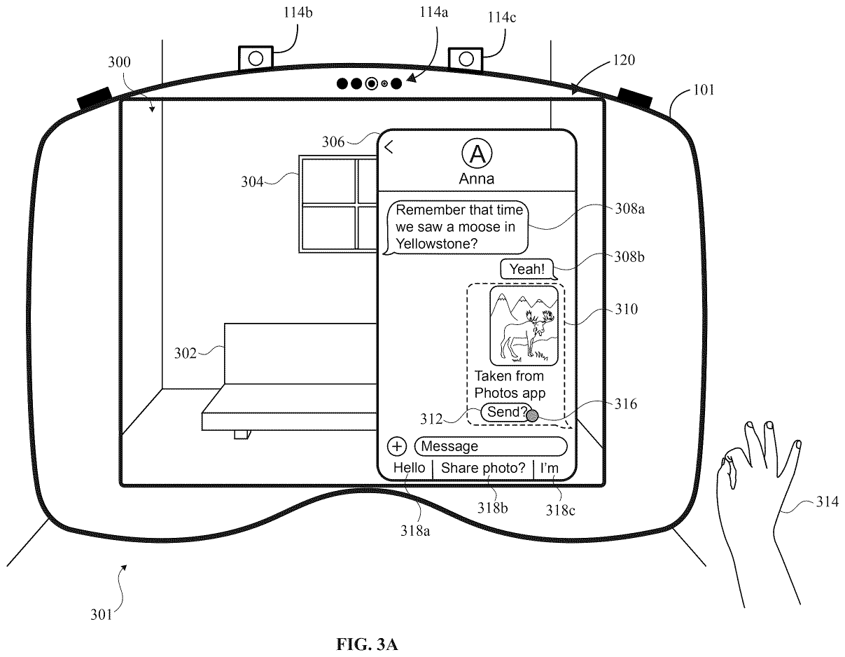

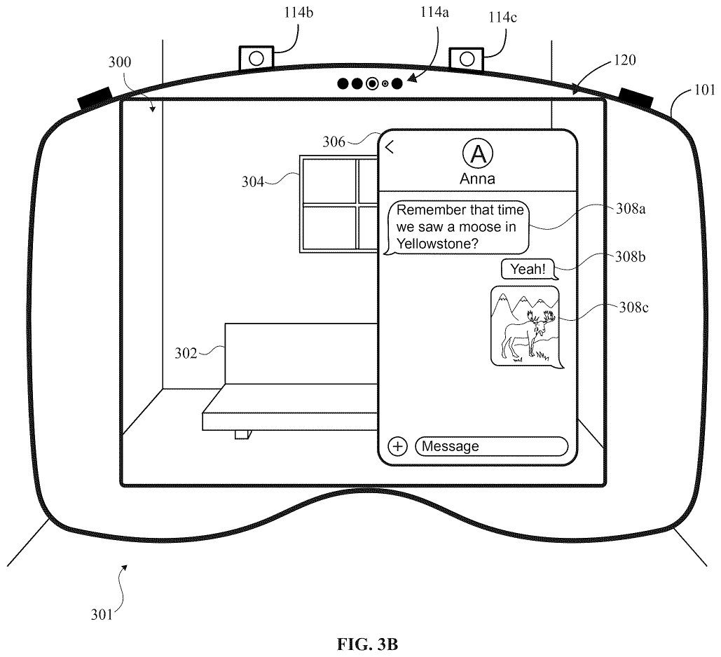

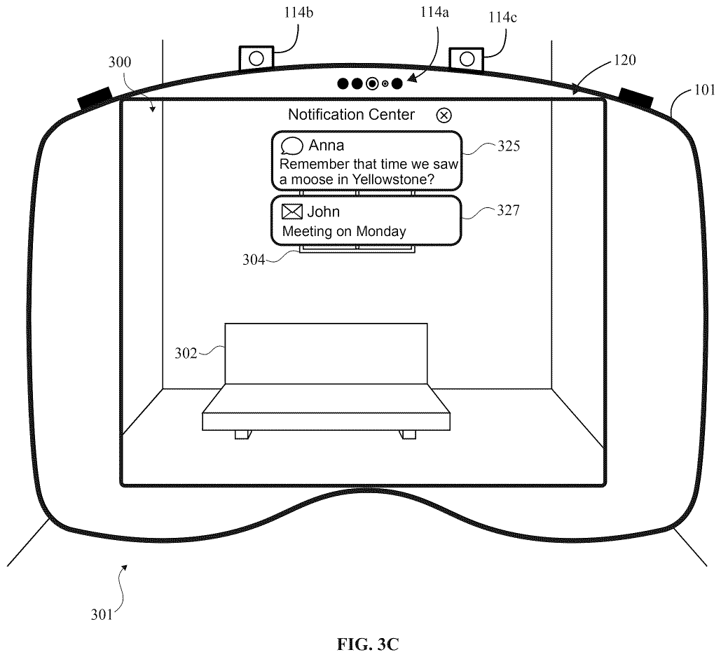

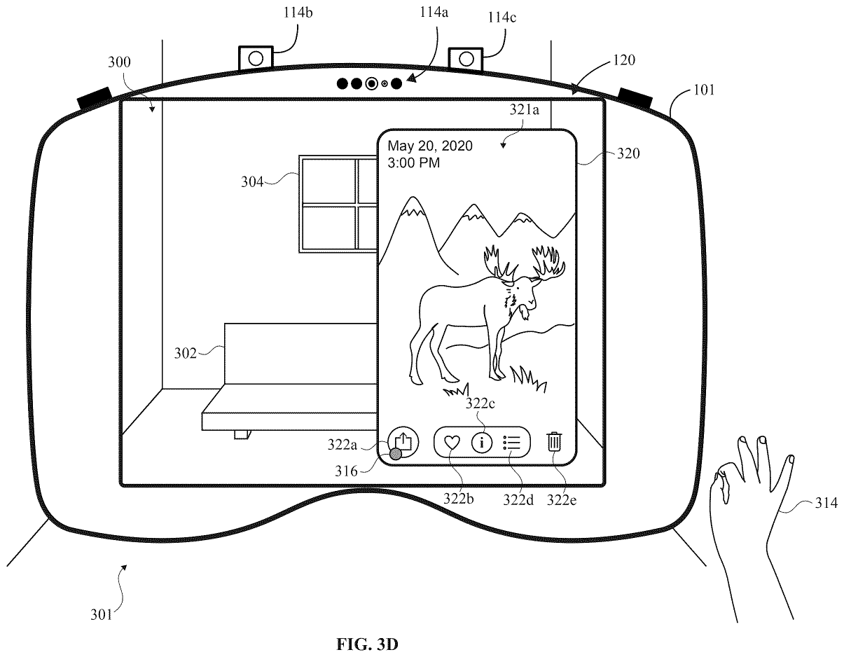

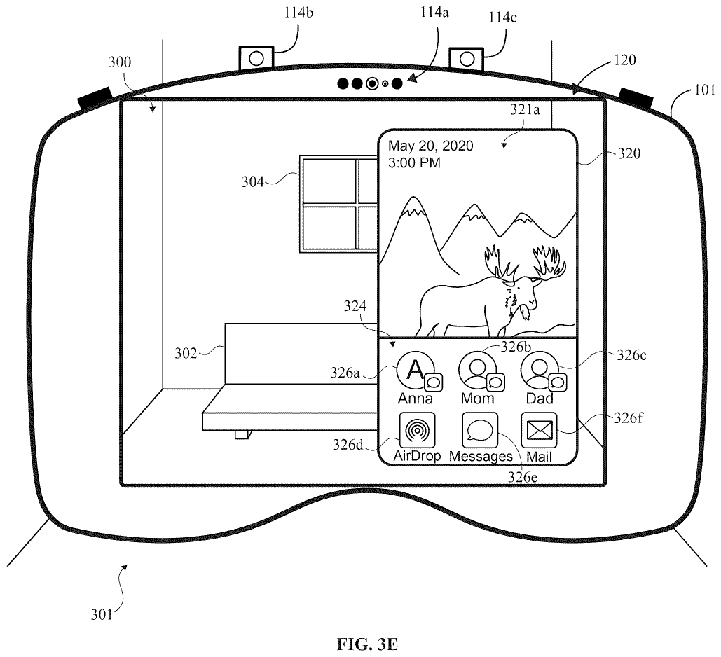

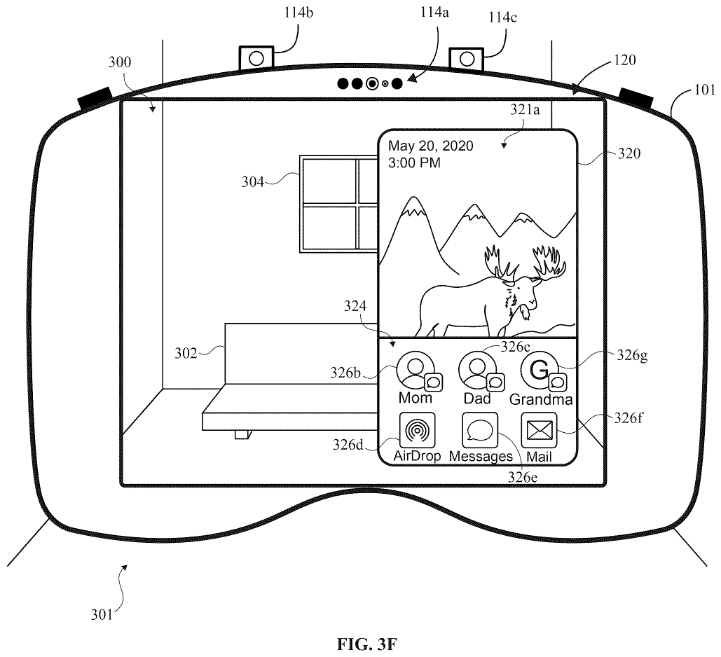

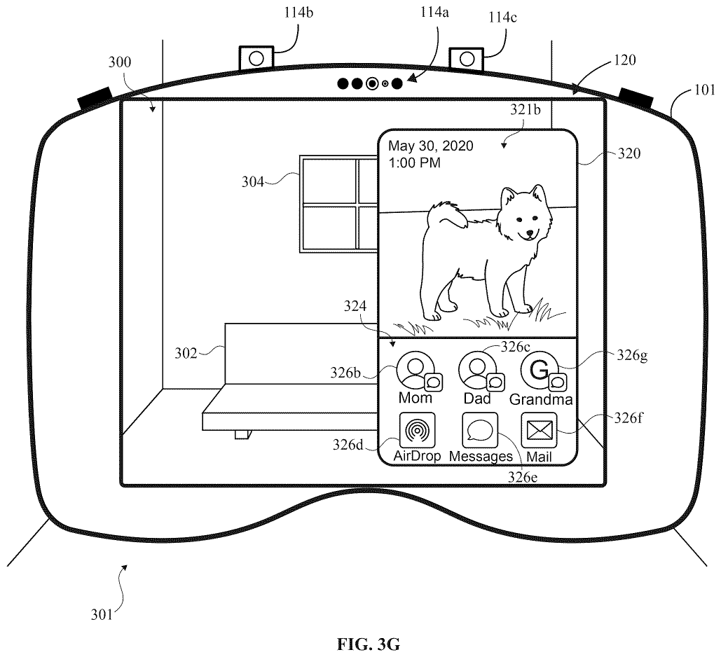

Although various examples, such as those illustrated in FIGS. 3A-6C, are described as including presenting a three-dimensional environment (e.g., with a head-mounted display), the disclosure is not limited to three-dimensional environments, user interfaces, and/or displays. Similar examples that include presentation of two-dimensional user interfaces are possible and do not depart from the scope of the disclosure. Examples of the disclosure can be implemented using a smartphone, computer, tablet, or other electronic device coupled to a two-dimensional display (e.g., a touch screen, monitor, and/or projector). For example, application user interfaces, notifications, images, and/or system user interfaces illustrated below as being presented in a three-dimensional environment can be presented in a two-dimensional user interface without departing from the scope of the disclosure.

FIG. 3A-3G illustrate examples of the electronic device providing information based on a first request for information. FIG. 3A illustrates an electronic device 101 presenting, via the display 120, a three-dimensional environment 300 from a point of view of the user of the electronic device 101. For example, the three-dimensional environment includes a room with a window 304 and a couch 302. FIG. 3A shows the user of the electronic device 101 is facing the couch 302 and the window 304 in a room in which electronic device 101 is located. In some examples, a viewpoint of a user determines what content (e.g., physical and/or virtual objects) is visible in a viewport (e.g., a view of the three-dimensional environment 300 visible to the user via one or more displays 120, a display, or a pair of display modules that provide stereoscopic content to different eyes of the same user). In some examples, the (virtual) viewport has a viewport boundary that defines an extent of the three-dimensional environment 300 that is visible to the user via the display 120 in FIGS. 3A-3F. In some examples, the region defined by the viewport boundary is smaller than a range of vision of the user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the user in one or more dimensions (e.g., based on the range of vision of the user, size, optical properties or other physical characteristics of the one or more displays, and/or the location and/or orientation of the one or more displays relative to the eyes of the user).

The viewport and viewport boundary typically move as the one or more displays move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and a direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include displays with video passthrough, portions of the physical environment that are visible (e.g., displayed, and/or projected) via the one or more displays are based on a field of view of one or more cameras in communication with the displays. The one or more cameras typically move with the displays (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more displays is updated based on the viewpoint of the user (e.g., displayed positions and poses of the virtual objects are updated based on the movement of the viewpoint of the user)). For displays with optical see-through, portions of the physical environment that are visible (e.g., optically visible through one or more partially or fully transparent portions of the display generation component) via the one or more displays are based on a field of view of a user through the partially or fully transparent portions of the display generation component (e.g., moving with a head of the user for a head mounted device or moving with a hand of a user for a handheld device such as a tablet or smartphone) because the viewpoint of the user moves as the field of view of the user through the partially or fully transparent portions of the displays moves (and the appearance of one or more virtual objects is updated based on the viewpoint of the user).

In FIG. 3A, the electronic device 101 includes a display 120 and a plurality of sensors as described above and controlled by the electronic device 101 to capture one or more images of a user or part of a user (e.g., one or more hands of the user) while the user interacts with the electronic device 101. In some examples, virtual objects, virtual content, and/or user interfaces illustrated and described below could also be implemented on a head-mounted display that includes a display or display generation component that displays the virtual objects, virtual content, user interfaces or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user). The figures herein illustrate a three-dimensional environment that is presented to the user by electronic device 101 (e.g., and displayed by the display 120 of electronic device 101). In some examples, electronic device 101 may be similar to electronic device 101 in FIG. 1, or electronic device 201 in FIG. 2, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively.

As shown in FIG. 3A, the electronic device 101 captures (e.g., using external image sensors 114b and 114c) one or more images of a physical environment 301 around electronic device 101, including one or more objects (e.g., couch 302 and window 304) in the physical environment 301 surrounding the electronic device 101. In some examples, the electronic device 101 displays representations of the physical environment 301 in the three-dimensional environment or portions of the physical environment 301 are visible via the display 120 of electronic device 101. For example, the three-dimensional environment 300 includes couch 302 and window 304 in the physical environment 301.

In FIG. 3A, the electronic device 101 displays a user interface 306 of a messaging application. In some examples, the electronic device 101 is in a first context determined by the electronic device 101 displaying a user interface 306 of a messaging conversation. The user interface 306 includes a messaging conversation between “Anna” and the user associated with electronic device 101. The user interface 306 includes a first conversation element 308a associated with a message sent by the electronic device associated with “Anna”, and displayed by electronic device 101 on user interface 306. The user interface 306 includes a second conversation element 308b associated with a message sent by the user associated with electronic device 101 to “Anna” and displayed by electronic device 101 on user interface 306. The user interface 306 also includes options 318a through 318c, corresponding to text insertion options. In some examples, the text insertion options correspond to frequently used text and/or text that the electronic device 101 predicts may be used to respond to a previous message (e.g., message in element 308a or 308b). In some examples, in response to receiving an input directed towards options 318a through 318c, the electronic device 101 adds the respective text to a message compose field.

In FIG. 3A, the electronic device 101 detects that the element 308a (and/or the message corresponding to the element 308a) includes a request for information. In some examples, the electronic device 101 uses one or more algorithmic, machine learning, and/or artificial intelligence methods to detect a request for information. For example, the electronic device 101 may use large language models to determine that the element 308a includes a request for information, the context for the request for information, and/or what type of information that is being requested. Additionally or alternatively, the electronic device 101 may identify words, phrases, punctuations, or the like, which are commonly associated with requests for information, along with words or phrases that are commonly associated with types of information that may be requested. In FIG. 3A, in response to detecting the request for information, the electronic device 101 displays indication 310, including a representation of a media item from a media library application on the electronic device 101. As shown in FIG. 3A, the representation of the media item corresponds to the information requested by the electronic device associated with “Anna”. In some examples, the electronic device 101 displays data directly from the application providing the data. For example, the electronic device 101 displays the representation of the media item in indication 310 directly from the media library application in FIG. 3A (e.g., embedding the image (displaying as a user interface element of the media library application within the user interface of the messaging application) rather than copying and/or summarizing the image (displaying as a user interface element of the messaging application)). In some examples, the electronic device 101 displays a user interface element of the media library application including the representation of the media item within the user interface of the messaging application. When selected, the user interface element of the media library application optionally causes the electronic device 101 to displays the representation of the media item in the media library application, such as shown in FIG. 3D.

In some examples, the electronic device indexes information (e.g., prior to receiving a request for information) stored on the electronic device 101 and/or stored remotely on a different electronic device associated with a user account of the electronic device (e.g., a cloud server, a second electronic device such as a smart watch, tablet, phone, and/or laptop, or other electronic devices associated with the user account with which the electronic device is associated). For example, the electronic device indexes data stored on the electronic device 101 or on a different electronic device associated with the electronic device 101, such as application data (e.g., messages data, emails, photos, music, calendar data, browsing data, and other application data). In some examples, in response to receiving a request for information, the electronic device 101 consults the index (e.g., queries the index) and suggests/displays information that corresponds to the request for information. For example, the electronic device 101 queries the index and displays indication 310, including a photo relevant to the request for information (e.g., the photo of the moose in response to a text message about the moose). In some examples, the electronic device 101 continuously adds data to the index as the electronic device 101 receives/stores additional data.

In FIG. 3A, the electronic device 101 receives a selection input 316 using an air-pinch gesture of hand 314, directed towards option 312. In some examples, the input is a touch input (e.g., with a contact such as a finger, stylus, or cursor). In some examples, the element illustrating input 316 is for illustrative purposes only and the electronic device 101 does not display the element. In some examples, the electronic device 101 displays a cursor or other indication at the location of the input 316 to provide visual feedback of the input. In some examples, the selection input may also include tap inputs, gaze inputs, and other direct and/or indirect selection inputs. In response to receiving the selection input in FIG. 3A, the electronic device 101 transmits the information in indication 310 to the electronic device associated with “Anna” and displays element 308c corresponds to a message in the messaging conversation, shown in FIG. 3B.

In some examples, the electronic device 101 receives a selection input directed towards the photo of the moose shown in indication 310. In response to receiving the input, the electronic device 101 displays a user interface of a media library including a representation of the photo, such as shown in FIG. 3D.

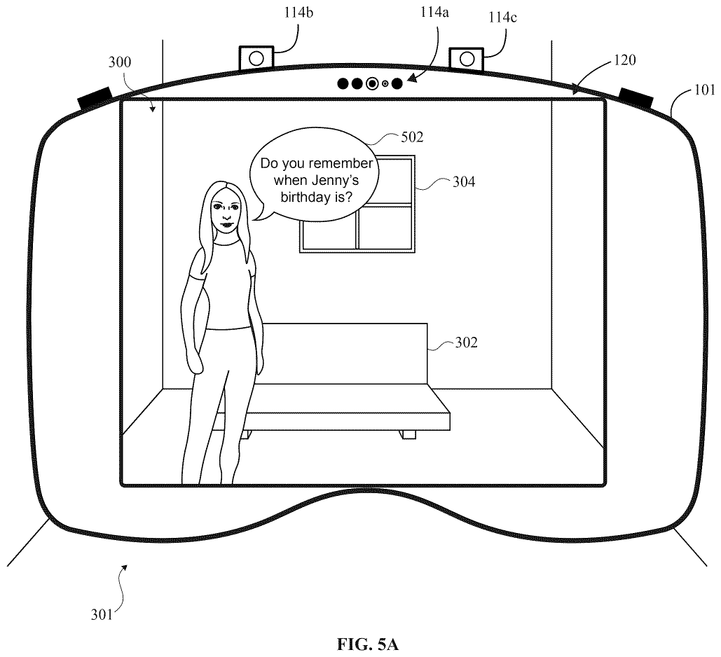

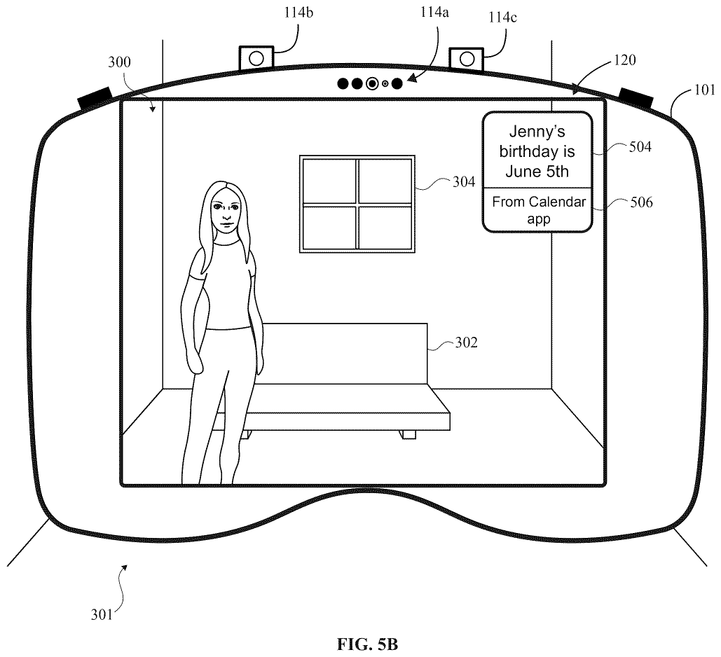

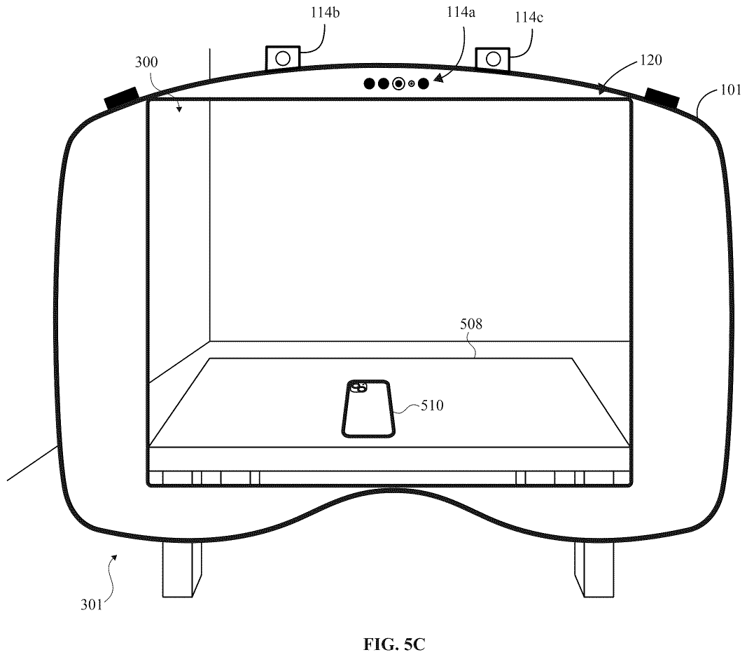

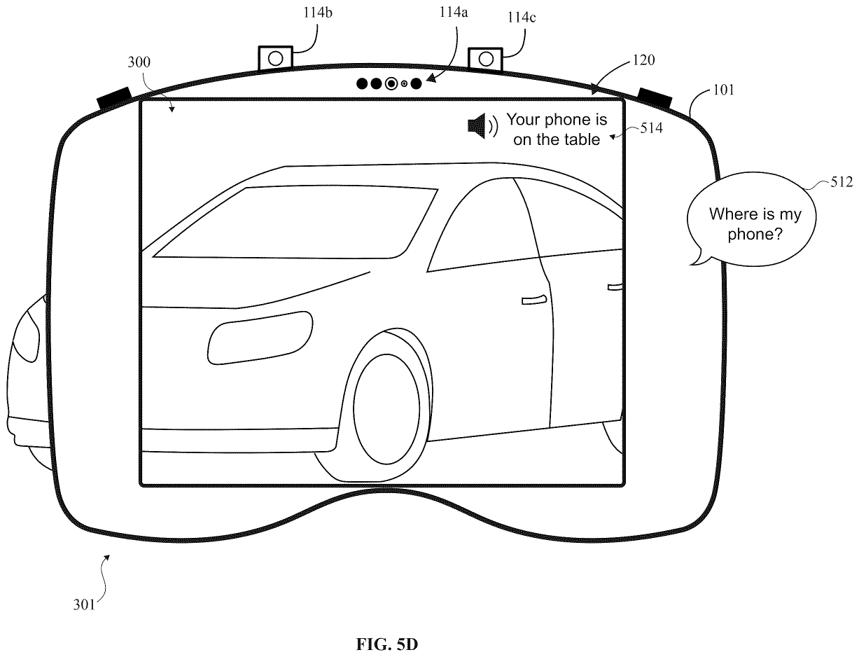

FIG. 3C illustrates an example where the electronic device 101 receives an indication of the request for information from the electronic device associated with “Anna” while not displaying a user interface of an application (e.g., a messaging application). Rather, the electronic device 101 is presenting a system user interface (e.g., while presenting a pass-through of the physical environment 301, or presenting the system user interface without a pass-through). While displaying the system user interface, the electronic device 101 receives an indication corresponding to the request for information and displays notification 325. In some examples, the electronic device 101 may display additional notifications while in the system user interface corresponding to indication from different applications (e.g., other than the messaging application), such as notification 327, corresponding to a notification from an email application. In some examples, the electronic device 101 may display a suggestion to the request for information while displaying notification 325 in the system user interface, such as shown in FIG. 5B.

FIG. 3D illustrates the electronic device 101 in a second context after receiving the request for information. In some examples, the electronic device 101 receives an indication of the message corresponding to element 308a while displaying a user interface other than a user interface of the messaging application, such as a system user interface (e.g., as shown in FIG. 3C) or the user interface of an application other than the messaging application. In some examples, in response to receiving the indication corresponding to element 308a, shown in FIG. 3A, the electronic device 101 detects the request for information. In some examples, and as shown in FIG. 3D, after detecting the request for information, the electronic device 101 may suggest transmitting information corresponding to the request.

In FIG. 3D, the electronic device 101 displays a user interface 320 of a media library application. In some examples, the electronic device 101 automatically displays photo 321a when the media library application is open and in response to receiving the request for information (e.g., shown in FIG. 3A) corresponding to photo 321a. In some examples, if the request for information had been related to a second photo, then the electronic device 101 would automatically display the second photo when the media library application is open. In some examples, if the electronic device 101 has not received a request for information corresponding to a photo, then the electronic device 101 would not automatically display a photo based on the request for information. Instead, in some examples, the electronic device 101 may automatically display photos while the media library application is open based on recency and/or relevance and/or other criteria. The user interface 320 includes selectable options 322a through 322e. In some examples, option 322a, when selected, causes the electronic device 101 to share the photo 321a with one or more users or applications. In some examples, option 322b, when selected, causes the electronic device 101 to flag the photo 321a. In some examples, option 322c, when selected, causes the electronic device 101 to display metadata associated with the photo 321a. In some examples, option 322d, when selected, causes the electronic device 101 to display an editing user interface to change one or more features of the photo 321a. In some examples, option 322e, when selected, causes the electronic device 101 to delete the photo 321a. In FIG. 3D, the electronic device 101 displays a photo 321a of a moose. In some examples, the photo 321a includes metadata include a location corresponding to Yellowstone, and a date and/or time corresponding to a trip to Yellowstone. In some examples, while displaying the photo 321a of the moose in FIG. 3D, the electronic device 101 may display an indication including a suggestion to send the photo 321a to “Anna”, based on the request for information.

In FIG. 3D, the electronic device 101 receives a selection input with an air pinch from hand 314, directed towards option 322a, as illustrated with input 316. In response to receiving the input shown in FIG. 3D, the electronic device 101 displays a menu 324, shown in FIG. 3E.

In FIG. 3E, the electronic device 101 displays indications 326a through 326f, which are selectable to transmit the photo 321a to respective other electronic devices. In some examples, indications 326a through 326c correspond to a plurality of messaging conversations associated with a plurality of contacts. In some examples, in response to receiving an input directed towards a respective one of indications 326a through 326c, the electronic device 101 adds/transmits the photo 321a to the respective messaging conversation in the messaging application. In some examples, indication 326d, when selected, causes the electronic device 101 to transmit the photo 321a via a network (e.g., WiFi, near field communication, and/or Bluetooth). In some examples, indication 326e, when selected, causes the electronic device 101 to display a user interface of the messaging application such that a user may input a contact and/or location to transmit the photo 321a. In some examples, the indication 326f, when selected, causes the electronic device 101 to transmit the photo 321a to a mail application to be transmitted to a designed receiver.

In FIG. 3E, the electronic device 101 displays indication 326a, corresponding to a messaging conversation with “Anna”. The electronic device 101 displays indication 326a as the first indication because of the previously received request for information from “Anna”, shown in FIG. 3A. In some examples, if a third electronic device corresponding to second user had transmitted the request for information, then the electronic device 101 displays the indication corresponding to the second user, first.

FIG. 3F illustrates an example of user interface 320 including photo 321a when the electronic device 101 has not previously received a request for information to display the photo of the moose. In FIG. 3F, the electronic device does not display indication 326a as the first indication (or at all, as shown in FIG. 3F) because the electronic device 101 did not previously receive the request for information to display the photo of the moose from “Anna”, which corresponds to indication 326a. Instead, in FIG. 3F, the electronic device displays indications 326b through 326g, where indications 326b, 326c, and 326g corresponds to messaging conversations with the three most commonly contacted contacts of the user of electronic device 101, or some other criteria not related to requests for information. In some examples, “Anna” is not a commonly contacted contact.

FIG. 3G illustrates an example of user interface 320 including a photo 321b. The electronic device 101 has not received a request for information to cause the electronic device 101 to display a photo 321b of a dog. The electronic device 101 receives a request for information correspond to a photo 321a of a moose, as described above. As such, menu 324 does not include indication 326a, corresponding to the messaging conversation with “Anna”, who transmitted the request for information corresponding to the photo of the moose.

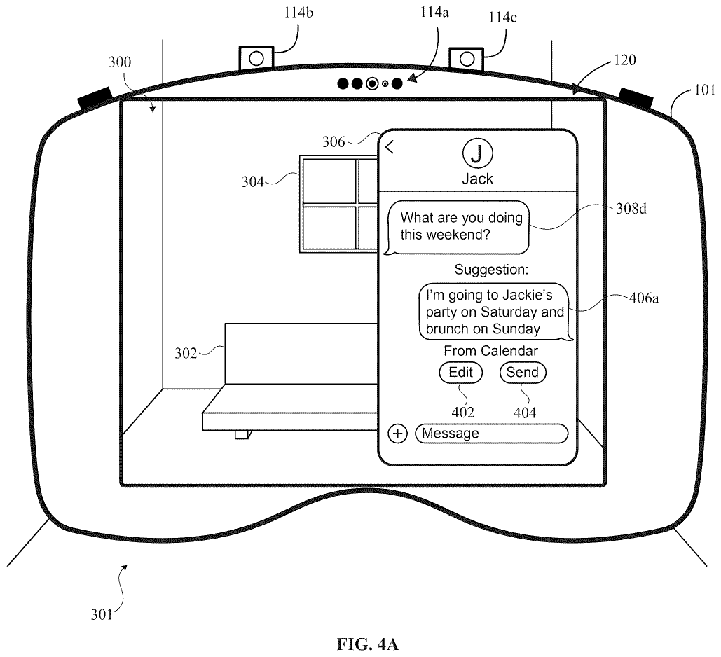

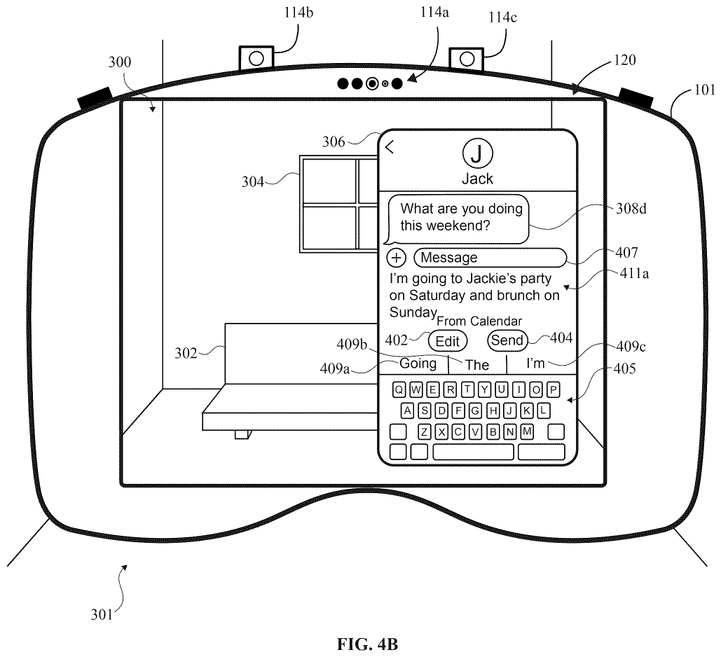

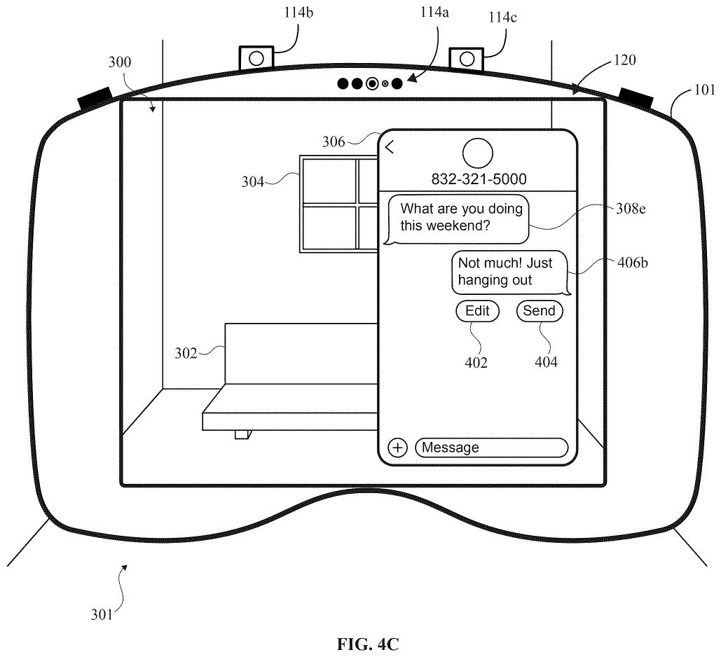

FIGS. 4A-4C illustrate an example of the electronic device providing information based on a second request for information. In FIG. 4A, the electronic device 101 displays user interface 306 including a messaging conversation between “Jack” and the user of the electronic device 101. In FIG. 4A, the electronic device 101 receives a message from an electronic device associated with “Jack” and displays element 308d in response to receiving the message. In some examples, element 308d represents a message that corresponds to a request for information. In some examples, the electronic device 101 receives the request for information with or without the user interface 306 being displayed. In some examples, the electronic device 101 uses one or more algorithmic, machine learning, and/or artificial intelligence methods, as described above, to determine that the message corresponding to element 308d includes a request for information. In FIG. 4A, the electronic device 101 is in a first context based on the sender of the element 308d (e.g., “Jack” is a known contact because Jack's phone number is stored/saved on the electronic device 101) and based on content of the request for information. In some examples, if the sender of the element 308d were an unknown sender, as described below, then the suggestion for responding to the request for information may be different. As shown in FIG. 4A, in response to receiving the request for information, the electronic device 101 displays a suggestion for responding to the request for information, as indication 406a. In some examples, the electronic device 101 uses data from a calendar application because the contents of the request for information (e.g., what is being requested) is requesting event/activity information. In FIG. 4A, the suggestion shown on indication 406a includes detailed information regarding the user's activities for the weekend based on calendar events. Indication 406a includes text describing the location that the information originated from (e.g., the calendar application). Additionally, electronic device 101 displays options 402 and 404 below indication 406a. In some examples, option 402, when selected, causes the electronic device 101 to display a content entry field for editing the contents of the suggestion. In some examples, option 404, when selected causes the electronic device 101 to transmit the contents of indication 406a to the electronic device associated with “Jack”.

FIG. 4B illustrates a different example in which the electronic device 101 may display a suggestion in response to the request for information. In some examples, rather than displaying the suggestion as indication 406a, shown in FIG. 4A, the electronic device 101 displays the suggestion as an option 411a as a text insertion option, which is described in greater detail in FIG. 3A. In FIG. 4C, the electronic device 101 displays options 409a through 409c and keyboard 405. In some examples, options 409a through 409c are automatically generated suggested text (e.g., autosuggestions) generated by the electronic device 101. In some examples, the electronic device 101 displays automatically generated suggested text based on previous messaging activity and/or suggestions based on requests for information. In some examples, options 409a through 409c, when selected, cause the electronic device to add the respective text into content entry field 407. Optionally, the electronic device sends the contents of content entry field 407 to the electronic device associated with “Jack” in response to receiving an input requesting to transmit a message to the messaging conversation. In some examples, in response to detecting a request for information, the electronic device 101 may display an autosuggestion including a suggestion for a response to the request for information. For example, as shown in FIG. 4B, the electronic device 101 displays option 411a, which includes text (e.g., information) that is relevant to the request for information transmitted by the electronic device associated with “Jack”.

FIG. 4C illustrates an example of the electronic device generating a suggestion for the request for information while in a second context. In some examples, the context of the electronic device 101 is based on the sender of the request for information. In FIG. 4C, an electronic device associated with an unknown user account (e.g., unsaved number “832-321-5000”) transmits a message including a request for information, which is displayed as element 308e. In some examples, element 308e appears similarly to element 308d, shown in FIG. 4A, except element 308e indicates a message from an unknown user account whereas element 308d indicates a message from a known contact. However, unlike in FIG. 4A, the electronic device 101 does not display a suggestion including information from the calendar application in response to receiving the message from the unknown user account. In FIG. 4C, the electronic device 101 displays indication 406b, including a suggestion for a response to the request for information. Indication 406b does not include details about the user's events for the weekend because the messaging conversation is with an unknown user account (e.g., not stored as a contact on electronic device 101).

FIGS. 5A-5D illustrate a different example of an electronic device receiving a request for information from a different source and providing the respective information. In FIG. 5A, the electronic device 101 detects a request for information using one or more input devices (e.g., a microphone). In some examples, the electronic device 101 may receive the request for information from other sources other than applications and/or other electronic devices. For example, in FIG. 5A, the electronic device 101 receives the request for information from a person in the physical environment of the electronic device 101, rather than from a different electronic device (e.g., via a text message). It should be appreciated that in FIG. 5A, the person making the request for information is within the field of view of the electronic device 101, but in some examples, the person making the request for information is outside of the field of view of the electronic device 101. In FIG. 5A, the electronic device 101 uses one or more algorithmic, machine learning, and/or artificial intelligence methods to determine that the audio includes a request for information, specifically a request for information using calendar data from a calendar application.

In response to receiving the request for information, the electronic device 101 displays an indication 504 including a suggestion for a response to the request for information, and an indication 506 including a source of the information, as shown in FIG. 5B. In some examples, and as described above, the electronic device may query calendar data (e.g., that was previously indexed) to determine relevant data for the request for information.

FIGS. 5C-5D illustrate an example where the user of the electronic device 101 may request information and receive information based on environmental data. In FIG. 5C, the electronic device 101 presents a view of the physical environment including electronic device 510 on table 508. In some examples, the electronic device 101 presents the electronic device 510 and the table 508 because the electronic device 510 and the table 508 are in the field of view of the user and the user is optionally gazing at the electronic device 510. In some examples, the electronic device 101 may capture environmental data based on camera (e.g., inward facing and/or outward facing cameras, as described in FIG. 2) and microphone data. In some examples, the electronic device 101 captures environmental data relating to electronic device 510 (e.g., the location of electronic device 510) because the electronic device 510 is in communication with electronic device 101. For example, electronic device 510 may be wireless connected to electronic device 101 (e.g., via Bluetooth, WiFi, near-field communication, or other wireless communication). The electronic device 101 and electronic device 510 may also share a user account.

In FIG. 5D, the electronic device 101 is no longer presenting the portion of the physical environment including electronic device 510 and table 508 in the three-dimensional environment 300 and receives a request for information 512 from the user of electronic device 101. For example, the electronic device 101 may detect microphone data after detecting activation of a digital assistant of electronic device 101. In some examples, digital assistant(s) help a user perform various functions. For example, a digital assistant can provide weather updates, set alarms, and perform searches locally and/or using a network connection (e.g., the Internet) via a natural-language interface. In some examples, a digital assistant accepts requests at least partially in the form of natural language commands, narratives, requests, statements, and/or inquiries. In some examples, a user requests an informational answer and/or performance of a task using the digital assistant. For example, as shown in FIG. 5D, in response to receiving the question “Where is my phone?” the digital assistant answers “Your phone is on the table” (e.g., illustrated as indication 514 in FIG. 5D). In some examples, the electronic device 101 uses environmental data, as described above, to determine the answer that the phone (e.g., electronic device 510) is on the table. In some examples, the digital assistant can respond to the user in other forms, e.g., displayed alerts, text, videos, animations, music, etc. based on the contents of the request for information.

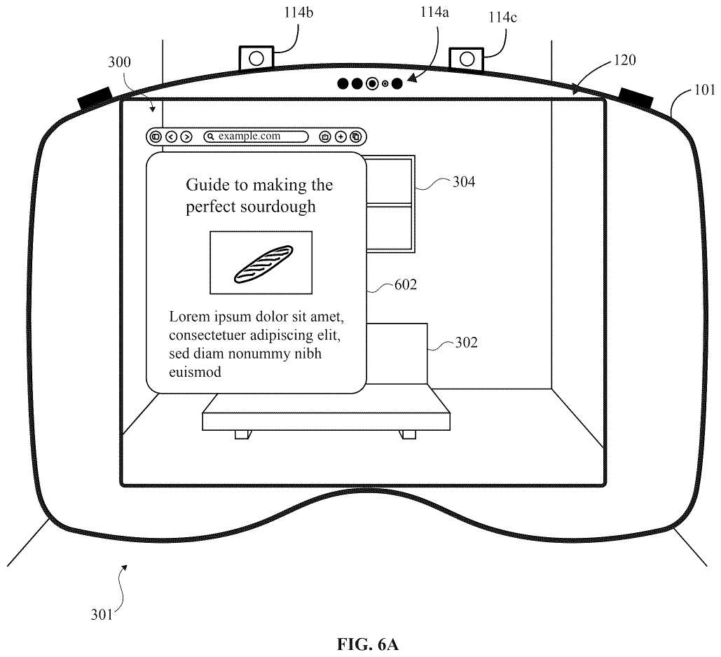

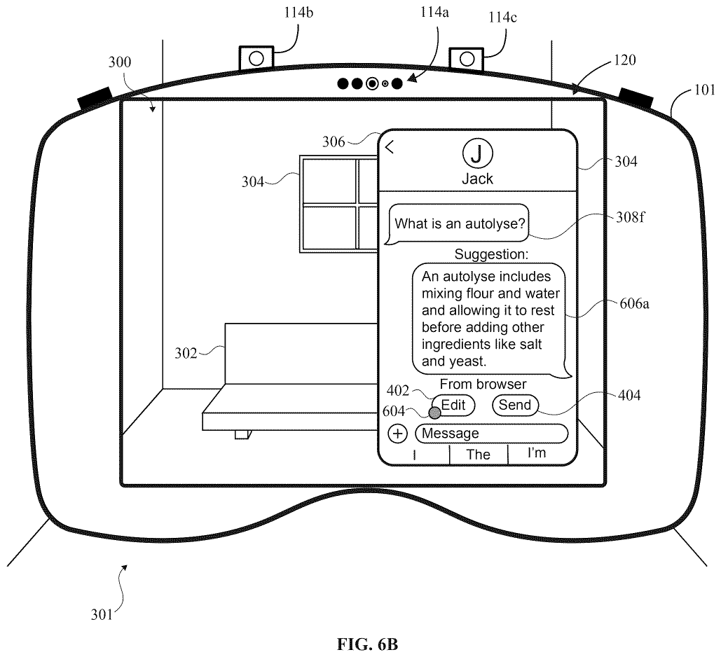

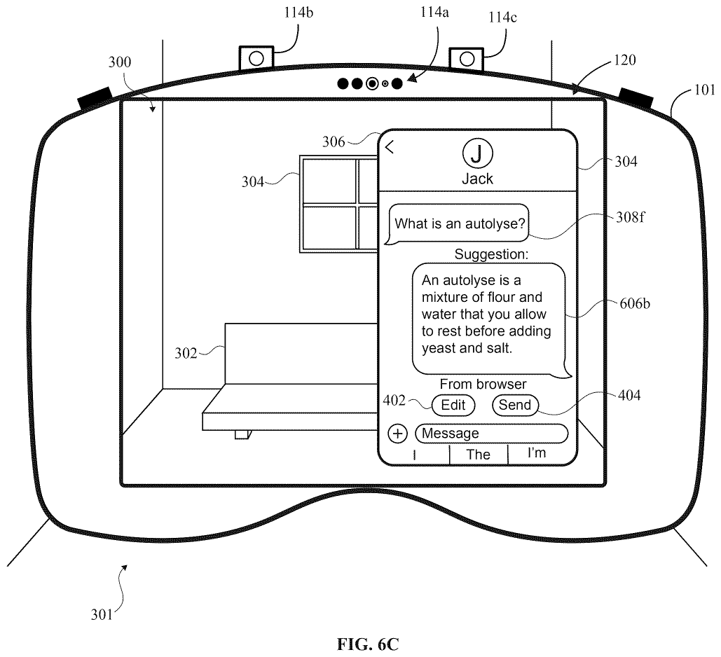

FIGS. 6A-6C illustrate an example where the electronic device 101 detects and summarizes information corresponding to the request for information. In FIG. 6A, the electronic device 101 displays a web browser user interface 602 of a bread making website (e.g., www.example.com). In some examples, the electronic device 101 detects gaze data corresponding to the user reading/viewing the website. In some examples, the electronic device 101 stores gaze data that is not associated with web browsing, such as gaze data while interacting with the physical environment (e.g., gaze data associated with the location of electronic device 510, as shown in FIG. 5C). In some examples, the electronic device 101 stores web browsing data irrespective of gaze data. In some examples, the electronic device 101 stores the gaze data and/or web browsing data and adds the data to the index of data, described above. In some examples, in response to detecting the web browsing shown in FIG. 6A, the electronic device 101 summarizes the content of the web page using one or more algorithmic, machine learning, and/or artificial intelligence methods and adds the respective summary to the index. For example, the electronic device 101 stores the respective summary locally or on an electronic device in communication with electronic device 101 (e.g., cloud storage).

In FIG. 6B, the electronic device 101 displays the messaging user interface 306 including a messaging conversation with an electronic device associated with “Jack”. The electronic device 101 receives a message including a request for information and displays element 308f including the message. In response to receiving the request for information (“What is an autolyse?”), the electronic device 101 displays an indication 606a including a suggestion for the response to the request. In some examples, the electronic device 101 queries the index of information, which includes the summary and/or content from the previously browsed website, shown in FIG. 6B. In FIG. 6B, the indication 606a includes a summary of a portion of the website that includes information corresponding to the request for information. In some examples, the electronic device 101 generates the suggestion using one or more machine learning and/or artificial intelligence methods to summarize the content of the previously-browsed webpage. In some examples, after receiving the request for information, if the electronic device 101 does not have information corresponding to the request for information, then the electronic device 101 does not display a suggestion. However, in some examples, if the electronic device 101 receives one or more inputs to browse a web browser including information relevant to the request for information, then the electronic device 101 may display a suggestion after detecting that the index includes relevant information.

In FIG. 6B, the electronic device 101 detects a gaze input 604 directed towards option 402 to edit the suggestion of indication 606a. In some examples, the input 604 may be a different selection input such as air-pinch or a tap with a contact (e.g., a stylus, cursor, and/or finger). In response to receiving the input, the electronic device displays one or more content editing fields to receive text or audio to edit the text of indication 606a.

In FIG. 6C, the electronic device 101 displays indication 606b, including the edits to the suggestion from FIG. 6B. In some examples, the electronic device 101 may identify and/or store the one or more edits to inform further suggestions to requests for information. For example, the electronic device 101 may detect writing style and/or omitted information and use the respective data for future suggestions (e.g., by forming suggestions in the same writing style or continuing to omit information previously deleted).

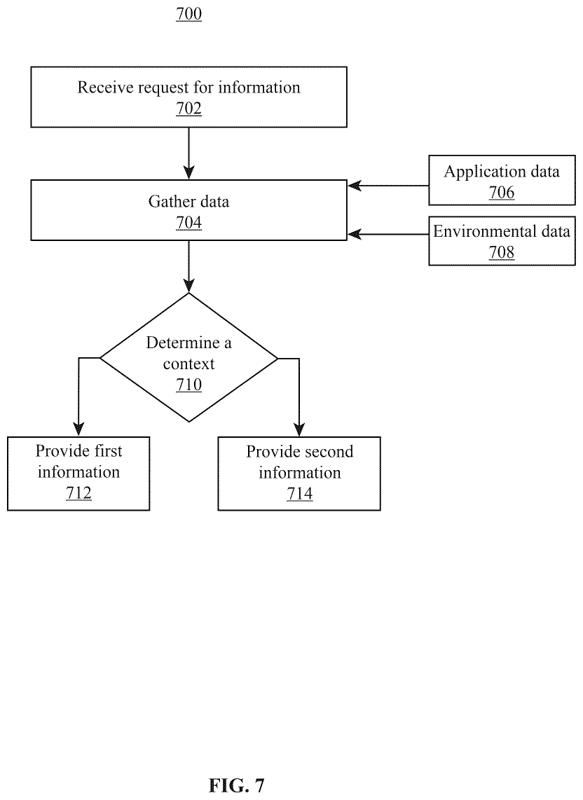

FIG. 7 illustrates a block diagram illustrating the process for providing a suggestion to a request for information. Process 700 starts at block 702. At block 702, the electronic device 101 receives a request for information (e.g., from an application, a person via audio sensors, and/or from a digital assistant). At block 704, the electronic device 101 gathers data after receiving the request for information. In some examples, the electronic device 101 gathers data by querying an index of data including application data (706) and environment data (708). In some examples, application data includes data from one or more applications downloaded/saved on the electronic device 101 (e.g., calendar data, web browsing data, messaging data, media library data, maps data, and other application data). In some examples, environmental data includes audio data, gaze data, camera data, and other data captured by the one or more input devices in communication with electronic device 101. At block 710, the electronic device 101 determines a context based on the data gathered and/or the contents of the request for information. Based on the context, the electronic device 101 provides first information (712) or second information (714), as described above.

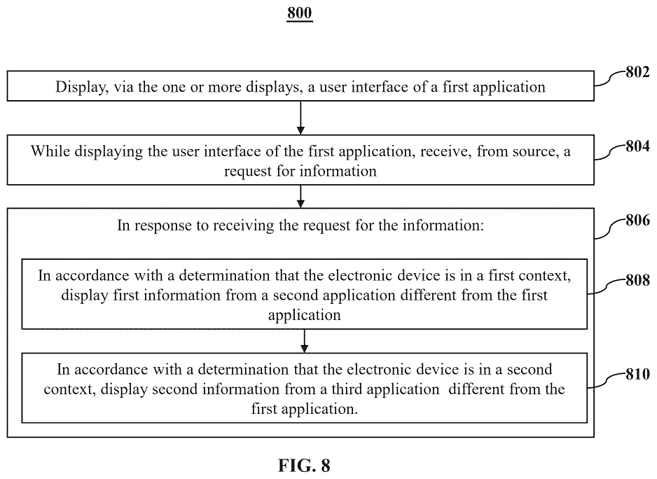

FIG. 8 illustrates a flow diagram illustrating an example process for displaying suggestions to requests for information according to some examples of the disclosure. In some examples, process 800 begins at an electronic device in communication with one or more display and one or more input devices. In some examples, the electronic device is optionally a head-mounted display similar or corresponding to device 201 of FIG. 2. As shown in FIG. 8, in some examples, at 802, the electronic device displays, via the one or more displays, a user interface of a first application. For example, the electronic device (e.g., electronic device 101 in FIG. 3A) presents a three-dimensional environment, such as three-dimensional environment 300, that includes a user interface 306 of a messaging application.

In some examples, at 804, while displaying the user interface of the first application, the electronic device receives, from a source, a request for information. For example, the electronic device detects a message transmitted from a second electronic device associated with “Anna” and displays element 308a corresponding to the message, which includes the request for information, shown in FIG. 3A. In some examples, the electronic device receives the request for information from the electronic device (e.g., from a digital assistant on the electronic device, such as shown in FIG. 5D, or from audio data on the electronic device, such as shown in FIG. 5A).

In some examples, in response to receiving the request for the information (806), in accordance with a determination that the electronic device is in a first context, the electronic device displays, at 808, a first information from a second application different from the first application. For example, in FIG. 3A, the electronic device 101 displays the suggestion (e.g., indication 310) from the media library application based on the context of the request for information in element 308a. In some examples, in response to receiving the request for the information (806), in accordance with a determination that the electronic device is in a second context, the electronic device displays, at 810, a second information from a third application different from the first application. For example, in FIG. 6B, the electronic device 101 displays the suggestion (e.g., indication 606a) from a web browser application based on the context of the request for information in element 308f. In some examples, while in the second context, the electronic device displays the second information from the second application or from the first application. For example, the electronic device 101 may display suggestions from the media library application and/or messages application (or other applications) based on the request for information.

It is understood that process 800 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising, at a first electronic device in communication with one or more input devices and one or more displays, displaying, via the one or more displays, a user interface of a first application; while displaying the user interface of the first application, receiving, from a source, a request for information; in response to receiving the request for the information: in accordance with a determination that the first electronic device is in a first context, displaying first information from a second application different from the first application; and in accordance with a determination that the first electronic device is in a second context, displaying second information from a third application different from the first application. Additionally or alternatively, in some examples, determining the first context and the second context includes determining a respective context using on-device application data. Additionally or alternatively, in some examples, determining the first context and the second context includes determining a respective context using environmental data. Additionally or alternatively, in some examples, determining the first context and the second context includes determining that a contact associated with the request for information corresponds to a known contact. Additionally or alternatively, in some examples, a source of the first information or the second information is based on data from a physical environment. Additionally or alternatively, in some examples, displaying a respective information includes displaying a source of the respective information. Additionally or alternatively, in some examples, displaying the first information or displaying the second information includes displaying a respective information as a summary generated using one or more machine learning methods. Additionally or alternatively, in some examples, the one or more machine learning methods receives data from a respective application corresponding to the respective context; and in response to receiving the data, generating the summary. Additionally or alternatively, in some examples, displaying the first information includes displaying a user interface element of the second application and displaying the second information includes displaying a user interface element of the third application. Additionally or alternatively, in some examples, while displaying respective information corresponding to the first information or the second information, receiving, via the one or more input devices, an input corresponding to a request to change the respective information; and in response to receiving the input, updating the display of the respective information in accordance with the request. Additionally or alternatively, in some examples, the user interface of the first application includes a content entry region, and the method further comprises: prior to receiving the request for information, displaying, via the one or more displays, a first selectable option that, when selected, causes the first electronic device to enter the information corresponding to a third information not related to the first or second information to the content entry region, wherein: displaying the first information in response to receiving the request for the information includes displaying a second selectable option that, when selected, causes the first electronic device to enter the first information to the content entry region, and displaying the second information in response to receiving the request for the information includes displaying a third selectable option that, when selected, causes the first electronic device to enter the second information to the content entry region. Additionally or alternatively, in some examples, the method includes displaying, via the one or more displays, a system user interface; while displaying the system user interface: in response to receiving an indication of an event, concurrently displaying, via the one or more displays, an indication of the event in the system user interface and an indication of respective information, wherein: in accordance with the determination that the first electronic device is in the first context, the indication of the respective information includes the first information from the second application; and in accordance with the determination that the first electronic device is in the second context, the indication of the respective information includes the second information from the third application. Additionally or alternatively, in some examples, while displaying respective information corresponding to the first information or the second information, receiving, via the one or more input devices, a first input corresponding to a request to navigate to a respective application providing the respective information; and in response to receiving the first input, displaying the respective information in the respective application including a selectable option to share the respective information with the source; and while displaying the respective information in the respective application, receiving, via the one or more input devices, a second input directed towards the selectable option; and in response to receiving the second input, displaying the respective information in the first application as part of a messing conversation between the first electronic device and the source. Additionally or alternatively, in some examples, the method further comprises prior to receiving the request for information, indexing, via the one or more input devices, data stored on the first electronic device to create an index; and in response to receiving the request for the information: querying the index; and displaying, via the one or more displays, a suggestion to display relevant data in the index based on a context of the first electronic device. Additionally or alternatively, in some examples, the method includes detecting, via the one or more input devices, a gaze input directed towards one or more content items; in response to detecting the gaze input: summarizing the one or more content items using one or more machine learning methods; and adding the one or more content items and the summaries of the one or more content items to the index. Additionally or alternatively, in some examples, the method further includes while displaying respective information, receiving, via the one or more input devices, an input corresponding to a request to transmit the respective information to a second electronic device in communication with the first electronic device; and in response to receiving the input, transmitting an indication of the respective information to the second electronic device.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some instances, the data utilized may include personal information data that uniquely identifies or can be used to contact or locate a specific person. Such personal information data can include demographic data, content consumption activity, location-based data, telephone numbers, email addresses, social media ID's, home addresses, data or records relating to a user's health or level of fitness (e.g., vital signs measurements, medication information, exercise information), date of birth, or any other identifying or personal information. Specifically, as described herein, one aspect of the present disclosure is directed towards using application information and/or environmental information to suggest information for requests for information.

The present disclosure recognizes that the use of such personal information data, in the present technology, can be used to the benefit of users. For example, personal information data may be used to display suggestions to request for information. For example, the suggestions are based on browser history, application data, and/or environmental data.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more input devices and one or more displays:
displaying, via the one or more displays, a user interface of a first application;
while displaying the user interface of the first application, receiving, from a source, a request for information;
in response to receiving the request for the information:
in accordance with a determination that the first electronic device is in a first context, displaying first information from a second application different from the first application; and
in accordance with a determination that the first electronic device is in a second context, displaying second information from a third application different from the first application.

2. The method of claim 1, wherein determining the first context and the second context includes at least one of determining a respective context using on-device application data, using environmental data, or determining that a contact associated with the request for information corresponds to a known contact.

3. The method of claim 1, wherein a source of the first information or the second information is based on data from a physical environment.

4. The method of claim 1, wherein displaying a respective information includes displaying a source of the respective information and/or displaying the respective information as a summary generated using one or more machine learning methods.

5. The method of claim 1, wherein the user interface of the first application includes a content entry region, and the method further comprises:
prior to receiving the request for information, displaying, via the one or more displays, a first selectable option that, when selected, causes the first electronic device to enter the information corresponding to a third information not related to the first or second information to the content entry region, wherein:
displaying the first information in response to receiving the request for the information includes displaying a second selectable option that, when selected, causes the first electronic device to enter the first information to the content entry region, and
displaying the second information in response to receiving the request for the information includes displaying a third selectable option that, when selected, causes the first electronic device to enter the second information to the content entry region.

6. The method of claim 1, further comprising:
displaying, via the one or more displays, a system user interface;
while displaying the system user interface:
in response to receiving an indication of an event, concurrently displaying, via the one or more displays, an indication of the event in the system user interface and an indication of respective information, wherein:
in accordance with the determination that the first electronic device is in the first context, the indication of the respective information includes the first information from the second application; and
in accordance with the determination that the first electronic device is in the second context, the indication of the respective information includes the second information from the third application.

7. The method of claim 1, further comprising:
prior to receiving the request for information, indexing, via the one or more input devices, data stored on the first electronic device to create an index; and
in response to receiving the request for the information:
querying the index; and
displaying, via the one or more displays, a suggestion to display relevant data in the index based on a context of the first electronic device.

8. The method of claim 1, wherein the source is a person in a physical environment of the first electronic device or a second electronic device different from the first electronic device.

9. A first electronic device, comprising:
one or more processors;
one or more displays;
one or more input devices;
memory; and
one or more programs, wherein the one or more programs are stored in the memory and configured to be executed by the one or more processors, the one or more programs including instructions for:
displaying, via the one or more displays, a user interface of a first application;
while displaying the user interface of the first application, receiving, from a source, a request for information;
in response to receiving the request for the information:
in accordance with a determination that the first electronic device is in a first context, displaying first information from a second application different from the first application; and
in accordance with a determination that the first electronic device is in a second context, displaying second information from a third application different from the first application.

10. The first electronic device of claim 9, wherein determining the first context and the second context includes at least one of determining a respective context using on-device application data, using environmental data, or determining that a contact associated with the request for information corresponds to a known contact.

11. The first electronic device of claim 9, wherein a source of the first information or the second information is based on data from a physical environment.

12. The first electronic device of claim 9, wherein displaying a respective information includes displaying a source of the respective information and/or displaying the respective information as a summary generated using one or more machine learning methods.

13. The first electronic device of claim 9, wherein the user interface of the first application includes a content entry region, and the one or more programs further including instructions for:
prior to receiving the request for information, displaying, via the one or more displays, a first selectable option that, when selected, causes the first electronic device to enter the information corresponding to a third information not related to the first or second information to the content entry region, wherein:
displaying the first information in response to receiving the request for the information includes displaying a second selectable option that, when selected, causes the first electronic device to enter the first information to the content entry region, and
displaying the second information in response to receiving the request for the information includes displaying a third selectable option that, when selected, causes the first electronic device to enter the second information to the content entry region.

14. The first electronic device of claim 9, the one or more programs further including instructions for:
displaying, via the one or more displays, a system user interface;
while displaying the system user interface:
in response to receiving an indication of an event, concurrently displaying, via the one or more displays, an indication of the event in the system user interface and an indication of respective information, wherein:
in accordance with the determination that the first electronic device is in the first context, the indication of the respective information includes the first information from the second application; and
in accordance with the determination that the first electronic device is in the second context, the indication of the respective information includes the second information from the third application.

15. The first electronic device of claim 9, further comprising:
prior to receiving the request for information, indexing, via the one or more input devices, data stored on the first electronic device to create an index; and
in response to receiving the request for the information:
querying the index; and
displaying, via the one or more displays, a suggestion to display relevant data in the index based on a context of the first electronic device.

16. The first electronic device of claim 9, wherein the source is a person in a physical environment of the first electronic device or a second electronic device different from the first electronic device.

17. A non-transitory computer readable storage medium storing one or more programs, the one or more programs comprising instructions, which when executed by one or more processors of a first electronic device, cause the first electronic device to:
display, via one or more displays, a user interface of a first application;
while displaying the user interface of the first application, receive, from a source, a request for information;
in response to receiving the request for the information:
in accordance with a determination that the first electronic device is in a first context, display first information from a second application different from the first application; and
in accordance with a determination that the first electronic device is in a second context, display second information from a third application different from the first application.

18. The non-transitory computer readable storage medium of claim 17, wherein determining the first context and the second context includes at least one of determining a respective context using on-device application data, using environmental data, or determining that a contact associated with the request for information corresponds to a known contact.

19. The non-transitory computer readable storage medium of claim 17, wherein a source of the first information or the second information is based on data from a physical environment.

20. The non-transitory computer readable storage medium of claim 17, wherein displaying a respective information includes displaying a source of the respective information and/or displaying the respective information as a summary generated using one or more machine learning methods.

21. The non-transitory computer readable storage medium of claim 17, wherein the user interface of the first application includes a content entry region, and the one or more programs further causes the first electronic device to:
prior to receiving the request for information, display, via the one or more displays, a first selectable option that, when selected, causes the first electronic device to enter the information corresponding to a third information not related to the first or second information to the content entry region, wherein:
display the first information in response to receiving the request for the information includes displaying a second selectable option that, when selected, causes the first electronic device to enter the first information to the content entry region, and
display the second information in response to receiving the request for the information includes displaying a third selectable option that, when selected, causes the first electronic device to enter the second information to the content entry region.

22. The non-transitory computer readable storage medium of claim 17, wherein the one or more programs further causes the first electronic device to:
display, via the one or more displays, a system user interface;
while displaying the system user interface:
in response to receiving an indication of an event, concurrently display, via the one or more displays, an indication of the event in the system user interface and an indication of respective information, wherein:
in accordance with the determination that the first electronic device is in the first context, the indication of the respective information includes the first information from the second application; and
in accordance with the determination that the first electronic device is in the second context, the indication of the respective information includes the second information from the third application.

23. The non-transitory computer readable storage medium of claim 17, wherein the one or more programs further causes the first electronic device to:
prior to receiving the request for information, index, via one or more input devices, data stored on the first electronic device to create an index; and
in response to receiving the request for the information:
query the index; and
display, via the one or more displays, a suggestion to display relevant data in the index based on a context of the first electronic device.

24. The non-transitory computer readable storage medium of claim 17, wherein the source is a person in a physical environment of the first electronic device or a second electronic device different from the first electronic device.
